(19) United States
(12) Patent Application Publication
(10) Pub. No.: US 2025/0280297 A1
(43) Pub. Date: Sep. 4, 2025

(54) PRIVATE NETWORK SECURE ENCLAVES

(71) Applicant: Private Line, LLC., Las Vegas, NV (US)

(72) Inventors: Christopher Kitze, Las Vegas, NV (US); Russel Hyzen, Las Vegas, NV (US); David Paxton, Las Vegas, NC (US)

(21) Appl. No.: 18/592,338

(22) Filed: Feb. 29, 2024

(51) Int. Cl. H04W 12/43; H04W 12/062

(52) U.S. Cl. CPC H04W 12/43; H04W 12/062

(57) ABSTRACT

A method and system for enabling secure communication sessions is provided. A request from a first device is sent to a second device that relates to establishing a communication session between the first device and the second device. Each of the devices have an open SIM. The first device also has a closed SIM. An indication of a determination that the second device has a closed SIM is received, where the open and closed SIMs of the devices logically separate and distinct from each other. A communication session is established when the determination is received that the second device has the second device closed SIM. The communication session is established between the closed communication SIMs where the first device open SIM is disabled. Instead of using multiple SIMs, a split VPN tunnel can be used with a single SIM.

### TECHNICAL FIELD

The subject matter disclosed herein generally relates to communications between endpoints. Specifically, the present disclosure relates to establishing a secure communication session between various endpoints.

### TECHNICAL FIELD

Computing devices with communication capabilities have become ubiquitous. These devices are used to exchange information between different endpoints from different locations throughout the world. The information exchanged can include sensitive data, such as financial data, social security information, and other types of sensitive data.

In order to communicate, a communication session between a first device and a second device is established using local internet service providers. The communication session is routed from a first local internet service provider locally accessed by the first device to the second device through a public communication system, such as the public internet or a cellular-based network. The final leg of the communication session can be routed from the public communication system to the second device via a second local internet service provider locally accessed by the second device. The local internet service providers and the public internet present potential attack surfaces for other devices connected to the local internet service providers and the public internet. The devices along with the communication session can be exposed to security risks at any point. For example, the local internet service providers and/or the public communication system could be attacked by third devices. These attacks may take the form of malware, phishing, denial of service, and many other types of attacks. For example, malware can infiltrate either the first device or the second device or both devices and execute on one or both of the devices, such as gaining backdoor access to various systems, spy on a user's online activity, or steal sensitive data.

For example, once the first and/or second device have been infiltrated, through social engineering, sensitive data can be procured. In particular, a user associated with either the first device or the second device can be tricked into providing sensitive data, such as social security information, financial data, data that can be used to access other sensitive data, and/or providing funds.

Though attempts have been made to address these concerns, there is a need for an easy-to-use system, which combats this lack of security and privacy by use of private networks to exchange information without the use of the internet and/or phone networks. There is also a need for a system, which provides for convenient switching between a private mode and a normal mode.

### BRIEF DESCRIPTION OF THE DRAWINGS

Some embodiments are illustrated by way of example and not limitation in the figures of the accompanying drawings.

FIG. 1 is a network diagram illustrating a network environment 100 suitable for facilitating a secure communication session, according to some examples.

FIG. 2 is also a network diagram illustrating a network environment 100 suitable for facilitating a secure communication session, according to some examples.

FIGS. 3A and 3B illustrate SIMs for the user devices of FIG. 1, according to some example embodiments.

FIG. 4 shows a method for provisioning a private network for a secure communication session between at least two users is shown, according to some examples.

FIG. 5 illustrates a user interface that is displayed when a user device of FIG. 1 is in a private line mode, according to some example embodiments.

FIGS. 6A and 6B show communication flows associated with establishing a secure communication session, according to some example embodiments.

FIG. 7 shows a method for determining is a user device has a closed SIM, according to some example embodiments.

FIGS. 8 and 9 illustrate messages that can be send to a recipient device requesting the establishment of a secure communication session, according to some example embodiments.

FIG. 10 is a file tree that can be accessed by a communication when a device is private line mode, according to some example embodiments.

FIG. 11 illustrates a user interface that is displayed when a user device of FIG. 1 is in a monitor mode, according to some example embodiments.

FIG. 12 shows a data routing map that can be displayed on a user device of FIG. 1, according to some example embodiments.

FIGS. 13A-13C illustrate indicators that reflect an amount of packets dropped at locations of the data routing map of FIG. 12, according to some example embodiments.

Figure is a user interface that lists various hosts along with a packet loss percentage, according to some example embodiments.

FIG. 15 illustrates a user interface that is displayed when a user device of FIG. 1 is in a safeguard mode, according to some example embodiments.

FIG. 16 shows an available communication network list accessible by a user device of FIG. 1, according to some example embodiments.

FIG. 17 shows a list of eavesdroppers that can be displayed on a user device of FIG. 1, according to some example embodiments.

FIG. 18 illustrates an open connections list that can be displayed on a user device of FIG. 1, according to some example embodiments.

FIGS. 19A-19C illustrates fields of the user interface of FIG. 15 that reflect various levels of security threats associated with a user device of FIG. 1, according to some example embodiments.

FIG. 20 is a block diagram illustrating an example of a software architecture that may be installed on a machine, according to some example embodiments.

FIG. 21 is a diagrammatic representation of a machine in the form of a computer system within which a set of instructions may be executed for causing the machine to perform any one or more of the methodologies discussed herein, according to an example embodiment.

### DETAILED DESCRIPTION

Example methods and systems are directed to provisioning a private network for a secure communication session between at least two users. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A first user may desire to establish a secure communication session with a second user. A private network that overlays a communication system, such as communication system implemented by the internet of things (IoT), can be used that enables the secure communication session between the first and second users. Each of the first user and the second user can have first and second computing devices that can provision either a closed hardware subscriber identity module (SIM) or a closed embedded SIM (eSIM) for the secure communication session. As used herein, a closed SIM can refer to a SIM that can be used for a secure communication session. The closed SIM can be used during the secure communication session where all other forms of communication with a device having the closed SIM are closed off or disabled during the secure communication session. Also as used herein, a SIM can refer to either a hardware SIM or an eSIM. In examples, the closed SIM can be used exclusively for the secure communication session. Moreover, a closed SIM can be temporarily provisioned to the second user device.

The first computing device can have an open SIM that can be used for regular or open communications, such as messaging and phone calls over the internet and the publicly switched telephone network (PSTN). Likewise, the second computing device can have an open SIM that can be used for regular communications, such as messaging and phone calls similar to the open SIM of the first computing device. A secure communication session can be established using a closed, or secure SIM, which is logically separate and distinct from the open SIM.

In the first device, the open SIM can be a first hardware SIM at the first device and the closed SIM can be a second hardware SIM at the first device. Similarly, in the second device, the open SIM can be a first hardware SIM at the second device and the closed SIM can be a second hardware SIM at the second device. Alternatively, the open SIM can be a first eSIM at the first device and the closed SIM can be a second eSIM on the first device. Likewise, in the second device, the open SIM can be a first eSIM at the second device and the closed SIM can be a second eSIM at the second device. In some examples, the closed SIM can be temporarily provisioned on the second device during a secure communication session between the first device and the second device. Regardless, in both the first and second devices, the first eSIM and the second eSIM are logically separate and distinct from each other.

A first user may desire to establish a secure communication session with a second user. In examples discussed herein, the secure communication session can be established using a satellite based secure provider, such as Starlink™, or the like. In further examples, the secure communication session can be established using a split virtual private network (VPN). A first device associated with the first user can have first and second SIMs where the first SIM is an open SIM and the second SIM is a closed SIM. However, a second device associated with the second user may only has a first SIM, which corresponds to an open SIM but does not have a second SIM, which would correspond to the closed SIM for enabling the secure communication session. Here, the first user can have a pool of closed SIMs provided by a service provider. When the first user desires to establish a secure communication session with a second user that does not have a closed SIM, the first user can provision one the pooled SIMs for the second user. The provisioned SIM can be temporarily implemented on the second device to establish and enable the secure communication session between the first user and the second user via the first and second devices. Alternatively, the second user can have a closed SIM installed on the second device to allow for the secure communication session and subsequent secure communication sessions.

The secure communication session can be associated with an application where the secure communication session provides access to the application and data associated with the application. As used throughout, the term “application” can refer to a software instance or an application instance. The application can be exclusive to the secure communication session where the application can be used in coordination with other communication sessions. The data associated with the application can be shared via the secure communication session where both the first user and the second user can interact with the application exclusively with the secure communication session.

Once the secure communication session is established between the first device and the second device, all other functionality of the first and second devices can be automatically deactivated and/or disabled. Thus, functionality such as location services and communication services are deactivated or disabled where locations of the first device and the second device are not discernable during the secure communication session using location services. This can also extend to cameras and microphones implemented by the first and second devices. Similarly, any form of communication with the first device or the second device using the first SIM, where the second SIM is used to enable the secure communication session, such as communication between the first device and a third device or communication between the second device and fourth device, is disabled. In addition, any applications that are not associated with the secure communication session are disabled.

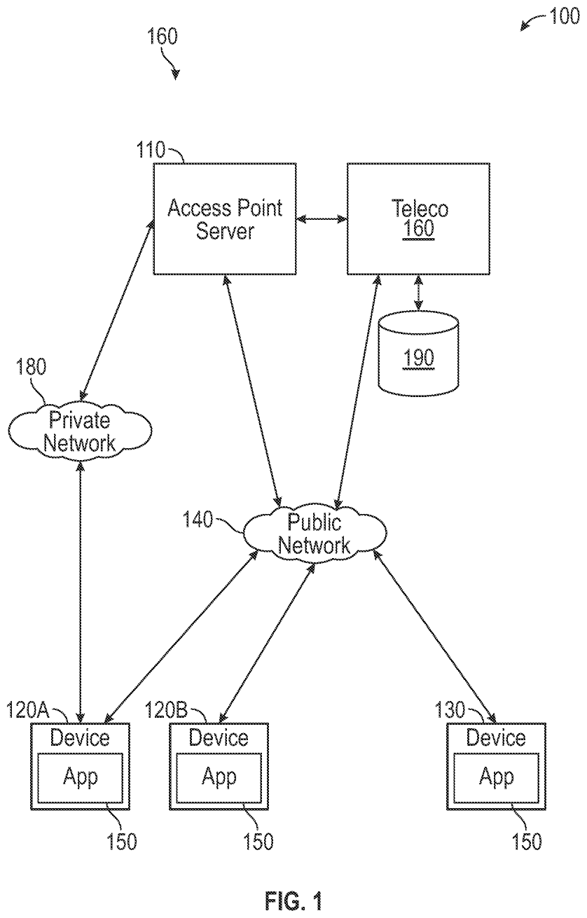

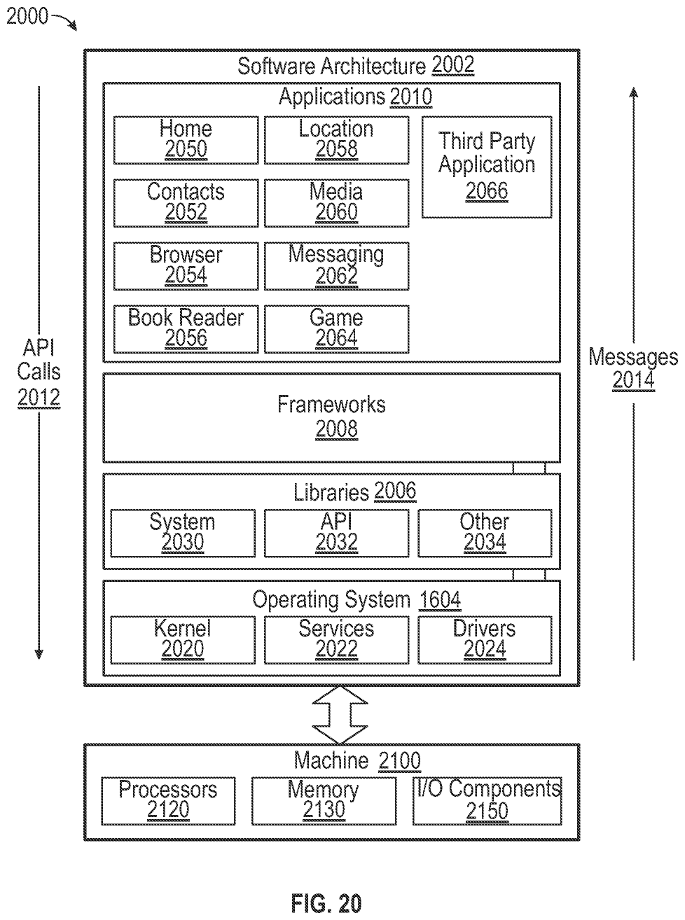

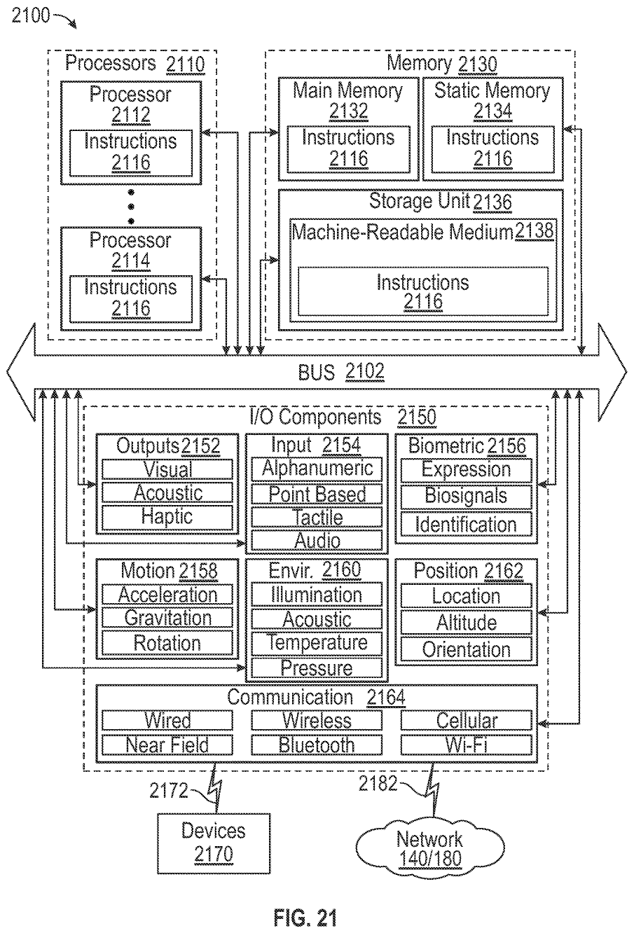

Now making reference to the Figures, FIG. 1 is a network diagram illustrating a network environment 100 suitable for provisioning a private network for a secure communication session between at least two users. The network environment 100 can include an access point server 110, along with devices 120A, 120B, and 130 communicatively coupled to each other via a public network 140. The devices 120A and 120B can be collectively referred to as “devices 120,” or generically referred to as “a device 120.” The devices 120 and 130 can interact with the access point server 110 using an application client 150. The application client can be implemented to provide secure communication sessions described herein. The server 110, the devices 120, and the device 130 may each be implemented in a computer system, in whole or in part, as described below with respect to FIGS. 20 and 21.

The access point server 110 can facilitate secure communications between each of the devices 120 and 130. In particular, the access point server 110 can receive requests from one of the devices 120 and 130 to establish a secure communication with another of the devices 120 and 130, such as if the device 120 sends a request to establish a secure communication session with the device 130. The access point server 110 can determine if the device 130 has separate open communication and closed communication SIMs. Moreover, in instances where the device 130 does not have a separate closed communication SIM, the access point server 110 can determine if a user associated with the device 120 has a provisioned a pool of eSIMs. The access point server 110 can make this determination by communicating with a teleco 160. The access point server 110 can provision a closed communication SIM to the device 130 when the device 120 has a pool of provisioned eSIMs with the teleco 150.

Moreover, the access point server 110 can include connection management software that store addresses associated with various users who are authorized to access a private network, as detailed further below. In some examples, the access point server 110 can store 255 addresses associated with 135 users. Furthermore, access to a private network can be limited to those entities that correspond to the 255 addresses thereby limiting communications to a subdomain defined by devices associated with the 255 addresses. It should be noted that examples are not limited to 255 addresses where the number of addresses can be scaled based on user requirements. Thus, an organization may require one-hundred thousand addresses, which can be provisioned for use in the subdomain.

The public network 140 may be any network that enables communication between or among machines, databases, and devices (e.g., the access point server 110 and the devices 120 and 130). Accordingly, the public network 140 may be a wired network, a wireless network (e.g., a mobile or cellular network), or any suitable combination thereof. The public network 140 may include one or more portions that constitute a private network, a public network (e.g., the Internet), or any suitable combination thereof.

The teleco 160 can be a provider of communication-based services, such as cellular-based communications, internet-based communications, or the like. The teleco 160 can function to determine if a user associated with the devices 120 and 130 has eSIMs pooled that can be temporarily provisioned to a device that a user associated with one of the devices 120 and 130 desires to establish a secure communication session via a provisioned private network.

In examples, when a secure communication session is established between the devices 120 and 130, a private network 180 can be utilized to facilitate the secure communication session. The access point server 110, in conjunction with a firewall 200, can disable all applications not authorized by the access point server 110. In addition, secure communication session applications that are preauthorized by the access point server 110 can be allowed to operate when the secure communication session is established. In some instances secure communication session applications can only run when a secure communication session is established. In other instances, a secure communication session application may be accessible as a device such as the user device 120A when a secure communication session is not established. A user may be able to access the secure communication session application in order to remove data from the secure communication session application and add data to the secure communication session application, such as adding and removing files from the secure communication session application. When the device 120A establishes a secure communication session with another device, such as the device 130, a user associated with the device 130 may be able to access the data, such as the file, added by a user associated with the device 120A, via the secure communication session. The combination of the access point server 110 and the firewall 200 can also disable existing network connections that the devices 120 have, such as a connection with the public network 104. The firewall 200 can function as a reverse firewall, where the firewall can block anything except approved applications from sending outside the firewall 200. An example of reverse firewall can be a firewall provided by Netguard™.

The private network 180 can work with a closed communication SIM logically or physically disposed at the devices participating in the secure communication session, such as the devices 120 and 130. The private network 180 can avoid publicly available communication mediums, such as a traditional publicly switched telephony system, which can include both circuit switched and packet switched communication systems, or the publicly available internet. The private network 180 can employ encrypted containers, which can be a file that stores other files where access to the file can only be obtained using appropriate software along with a password. The encrypted container can include software used to communicate over the secure communication via the private network 180 and data associated with the secure communication. In addition, while a single private network is described herein, secure communication sessions can be established across disparate private networks where a gateway can be used to facilitate communication among the disparate private networks.

The private network 180 can provide secure communication sessions via IoT connections, other types of wireless connections, wired connections, or satellite connections. Moreover, the private network 180 can provide secure connections via a quantum connection where entangled nodes can be used. The private network 180 can also interact with the teleco 160 similar to the manner in which the access point server 110 interacts with the Teleco 160, as discussed herein.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 20 and 21. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

In order to allow the devices 120 and 130 to communicate with both the public network 140 and the private network 180, the device 120 can include an open SIM 300 and the device 130 can include an open SIM 320 that each allow for communication via the public network 104. Moreover, when the device 120 initiates a secure communication, the device 120 can have a closed SIM 310 that allows for communication with the private network 180. Likewise, when the device 130 initiates a secure communication, the device 130 can have a closed SIM 330 that allows for communication with the private network 180. Each of the SIMS 300 and 310 can be hardware SIMs. The open SIM 300 can be a hardware SIM while the closed SIM can be an eSIM. In further examples, both the SIMs 300 and 310 can be eSIMs. In examples where the closed SIM 330 is an eSIM, as will be discussed further on, the recipient device may not have actually have the eSIM 330. In these examples, the initiating device may have access to a pool of eSIMs. Here, the initiating device can provision an eSIM, such as the SIM 330, from the pool of eSIMs to the recipient device in order to establish a secure communication.

The open SIM 300 can be logically separate and distinct from the closed SIM 310. In the example where the SIMs 300 and 310 are hardware SIMs, this can mean that the SIM 300 is physically different and therefore distinct from the SIM 310. The SIM 300 can be a hardware SIM card and the SIM 310 can also be a hardware SIM card. When the SIMs 300 and 310 are eSIMs, the SIM 300 can be separate from the SIM 310. The SIM 300 and the SIM 310 can be individual logical entities. In addition, one of the open SIM 300 and the closed SIM 310 can be a hardware SIM while the other of the open SIM 300 and closed SIM 310 can be an eSIM. The open SIM 320 and the closed SIM 330 of the device 130 can have the same characteristics as the open SIM 300 and the closed SIM 310 of the device 120.

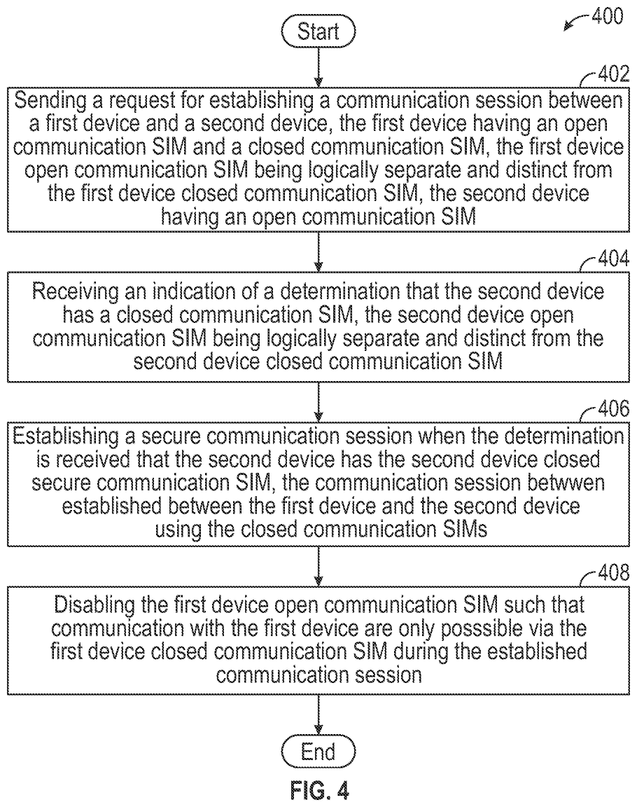

As mentioned above, examples relate to provisioning a private network for a secure communication session between at least two users. Now making reference to FIG. 4, a method 400 for provisioning a private network for a secure communication session between at least two users is shown, according to some examples. Initially, during an operation 402, a request for establishing a secure communication session between a first device, which can be an initiating device, and a second device, which can be a recipient device, is sent. The first device can have an open communication SIM and a closed communication SIM. Similarly, the second device can have an open communication SIM and a closed communication SIM. Moreover, each of the open communication SIMs and the closed communication SIMs can be logically separate and distinct from each other, as discussed above.

The request can be sent from a first device, such as one the devices 120 and 130, and received at the access point server 110. The first device can be associated with a service that facilitates secure network communications. The second device can also be associated with the service that facilitates secure network communications. The service can be engaged via a secure communication application on the first device. The secure communication application can include a selectable element, such as a user interface on the first device, that can be activated to place the first device in a secure communication mode. When in the secure communication mode, the first device can initiate secure communication sessions. When the second device is also associated with the service that facilitates secure network communications, the second device can also include the secure communication application where, when a requesting user at the first device activates the secure communication session via the secure network communication application, activation can cause a message to be sent to the second device.

In order to send the request, the secure communication session can be initiated when the selectable element is activated by a requesting user at the first device. When the selectable element is activated, the closed communication SIM of the first device can initiate a communication with a service provider, such as the teleco 160, by sending a request message to the service provider. In some instances, the second device can also be alerted to the request being sent when the second device includes the secure communication application.

The request message can include identification information associated with the first device. The identification information can include an International Mobile Station Equipment Identity (IMEI), IMEI data, an International Mobile Subscriber Identity (IMSI) number, a Mobile Subscriber Integrated Services Digital Network (MSISDN) number, a Mobile Equipment Identifier (MEID), or a Short Message Entity (SME).

The service provider can determine if the closed communication SIM associated with the first device is valid. In particular, the service provider can compare the identification information in the request message with a table of authorized users. If there is a match, the service provider can make the determination that the first device is authorized to send a request to the access point server 110 to initiate a secure communication. In response to receiving the authorization, the initiating device sends a request to the access point server 110 to establish a secure communication session with a recipient device.

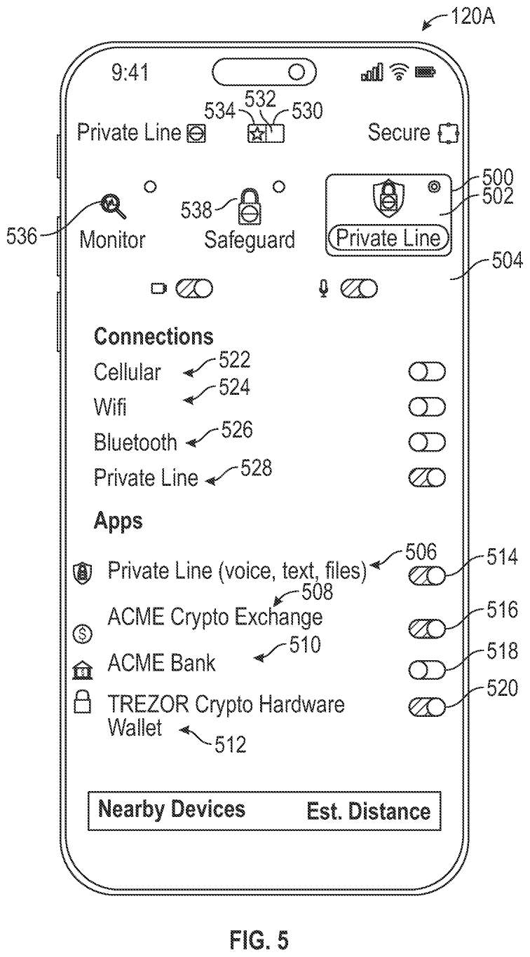

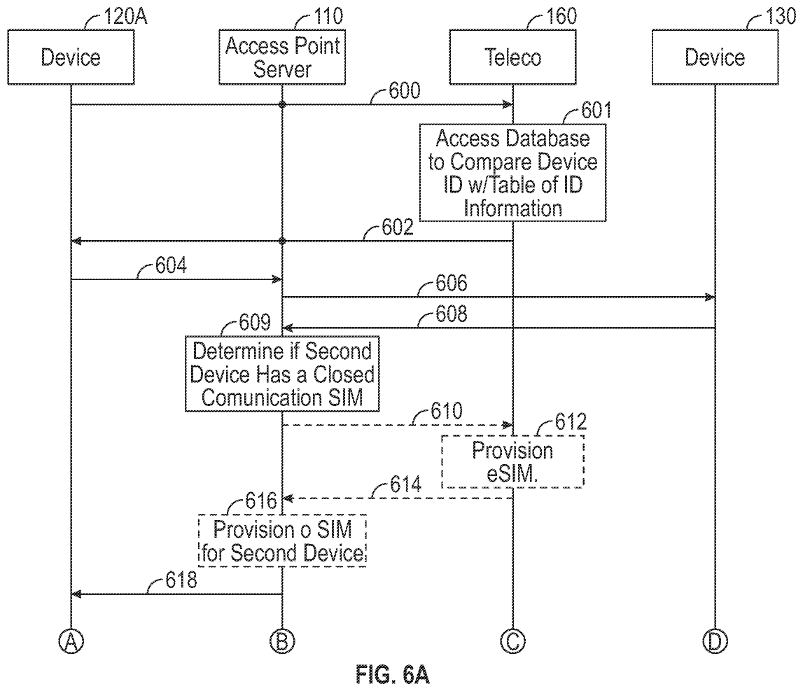

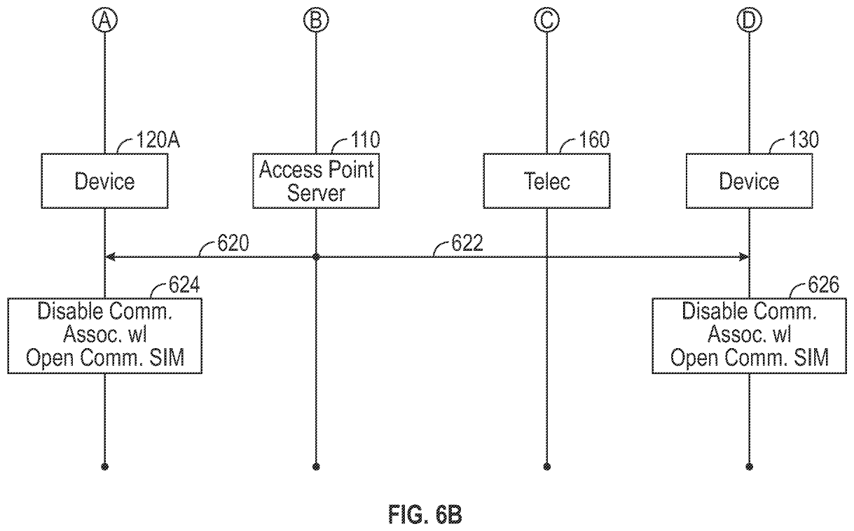

As an example of the method 400 and referred to herein as “the illustration,” making reference to FIGS. 5 and 6, during the operation 402, a requesting user at the device 120A desires to establish a secure communication session with the device 130. Thus, the requesting user selects a user interface element 500 associated with a secure communication application 502 that establishes a secure communication session with the device 130. The user interface element 500 can correspond to placing the device 120A in a secure communication mode. Selection of the user interface element 500 can indicate that the requesting user decides to establish and conduct a secure communication session via the access point server 110. In the illustration, the device 120A includes both the open SIM 300 and the closed SIM 310 while the device 130 only includes the open SIM 320. Moreover, the SIMS 300-320 are eSIMs. While the user interface element 500 is shown as correlating to a private communication mode, in examples, the user interface element 500 can be presented as an application unrelated to secure communication sessions, such as a game application, a photo application, a health application, or the like.

In response to the selection of the user interface element 500, a communication 600 is initiated with the teleco 160 via the closed SIM 310. The communication 600 can include the request and can be initially sent to the access point server 110, which can then forward the request along to the teleco 160. The communication 600 can include an IMEI of the device 120A. After the teleco 160 receives the communication along with the IMEI of the device 120A, the teleco 160 accesses a database 190 that can have a table of identification information as described above that is associated with authorized users. In the illustration, the teleco 160 determines that the IMEI of the device 120A is listed on the table of authorized users at 601. Therefore, the teleco 160 sends a response 602 indicating that the device 120A can send a request for establishing a secure communication session with the device 130 to the access point server 110. In particular, the teleco 160 informs the access point server 110 that the device 120A is authorized to communicate with the access point server 110 at 602. The device 120A can then proceed to send a request for establishing a secure communication session with the device to the access point server 110 at 604.

Returning attention to FIG. 4 and the method 400, after the request is sent to the access point server 110, the method performs an operation 404. During the operation 404, an indication is sent from the access point server that the second device has a closed communication SIM. Here, the open communication SIM of the second device is logically separate and distinct from the closed communication SIM of the second device.

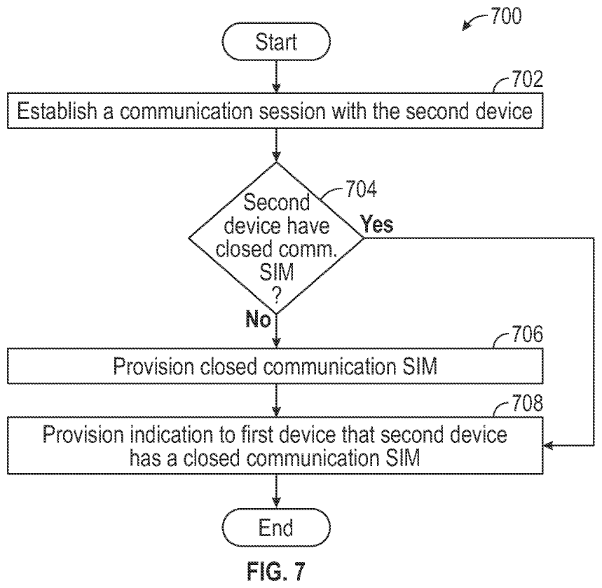

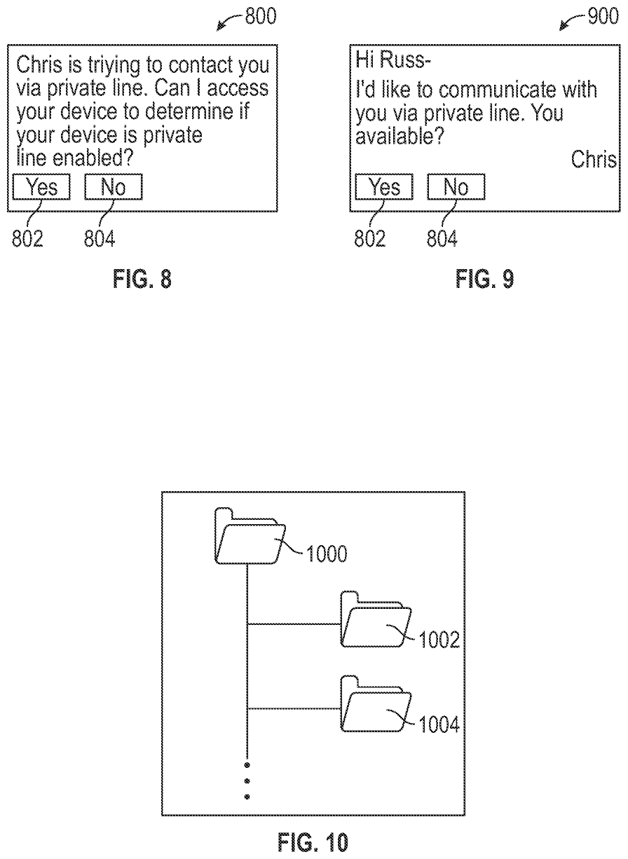

In examples, the access point server can determine if the second device has a closed communication SIM prior to sending the indication as shown with reference to FIG. 7 and a method 700. Initially, the access point server establishes a communication session with the second device during an operation 702. The communication session can be through a public network, such as the public network 140.

The access point server can send a message 800 to the second device, such as the device 130, as shown at 606 in FIG. 6. The message 800 can be displayed to a user associated with the second device indicating that the first device is trying to establish a secure communication session with the second device. The message 800 can also request permission for the access point server 110 to access the second device and determine if the second device is enabled to engage in a secure communication session. Throughout this disclosure, “Private Line” can relate to a private communication session. Regarding permission to access, this can be in the form of buttons 802 and 804. If the user selects the button 802, i.e., the user acknowledges that the device messaging application can access the device to determine if the device is configured to engage in a secure communication session. It should be noted that if the user selects the button 804, this can indicate that the user does not desire to engage in the secure communication session and the method 400 along with the method 700 are complete.

When the user selects the button 802, an indication is sent back to the access point server as shown at 608 that the user at the second device is willing to allow the access point server to determine if the second device is enabled for secure communication sessions.

When the second device sends an indication that the device is willing to allow the access point server to determine if the second device is enabled for secure communication sessions, an authentication process can occur where the second device can provide a login to the access point server along with a password that was previously encrypted. The second device can send the decrypted password to the access point server. Using the login and the decrypted password, the access point server can determine if the second device is authorized for secure communication sessions.

As noted above, the second device can have the secure communication application. In these instances, the first device can directly send a message 900 to the second device. The message 900 can be displayed to a user associated with the second device indicating that the first device is trying to establish a secure communication session with the second device. Similar to the message 800, the message 900 can also request permission for the access point server to access the second device and determine if the second device is enabled to engage in a secure communication session in the form of the buttons 802 and 804. In addition to the message 900, the first device can send a Quick Response (QR) code to the second device, which can provide the same functionality as the message 900.

Referring back to the illustration, during the operation 702, the access point server 110 sends the message 800 to the device 130 for display to a user associated with the device 130 at 606. The user associated with the device 130 is willing to engage in a secure communication session with the user associated with the device 120A. Thus, the user associated with the device 130 selects the button 802 and the indication is sent back to the access point server 110 at 308.

Returning to FIG. 7 and the method 700, once the access point server receives an indication that the user associated with the second device is willing to engage in a secure communication session, the method 700 performs an operation 704. During the operation 704, the access point server determines if the device is capable of establishing a secure communication session at 609. In particular, the access point server can access the second device and determine if the second device has a closed communication SIM, which can either be a hardware SIM or an eSIM.

If the second device does not have a second SIM, the access point server can determine if the user requesting the secure communication session has a pool of eSIMs that can be provisioned for the second device. In particular, the access point server can send a message to the teleco as shown at 610 to determine if the requesting user has a pool of eSIMs that can be provisioned. The message can also have a request to provision an eSIM from the pool if the requesting user has a pool of eSIMs. If the requesting user has a pool of eSIMs, the teleco can provision an eSIM for the second device as shown at 612. The teleco can then provide a response at 614 indicating that the requesting user does have a pool of eSIMs such that the access point can provision an eSIM for the second device at an operation 706. In some examples, instead of the teleco provision an eSIM, the access point server can provision the eSIM.

After the closed communication SIM has been provisioned during the operation 706, the access point server can provide a message to the first device that indicates the second device has a closed communication SIM during an operation 708, which can be received by the first device during the operation 404 and at 618.

Staying with FIG. 7, if a determination is made during the operation 704 that the second device does have a closed communication SIM, then the method 700 can skip to the operation 708.

Going back to the illustration, during the operation 702, the access point server 110 sends the message 800 to the device 130 at 606. A user at the device 130 selects the button 802, thereby indicating that the access point server 110 can access the device 130 to determine if the device 130 is enabled for the secure communication session and sends a response back at 608. At the operation 704 and at 609, the access point server 110 determines that the device 130 does not include a closed SIM. Thus, the access point server 110 communicates with the teleco 160 at 610 to determine if the requesting user at the device 120A has a pool of eSIMs at the teleco 160.

At 612, the teleco 160 determines that the requesting user at the device 120A has a pool of eSIMs and provides a response at 614 indicating that the requesting user does have a pool of eSIMs. Thus, the access point 110 provisions an eSIM for the device 130 during the operation 706 at 616. Moreover, the device 120A receives an indication that the device 130 has a closed eSIM during the operation 404.

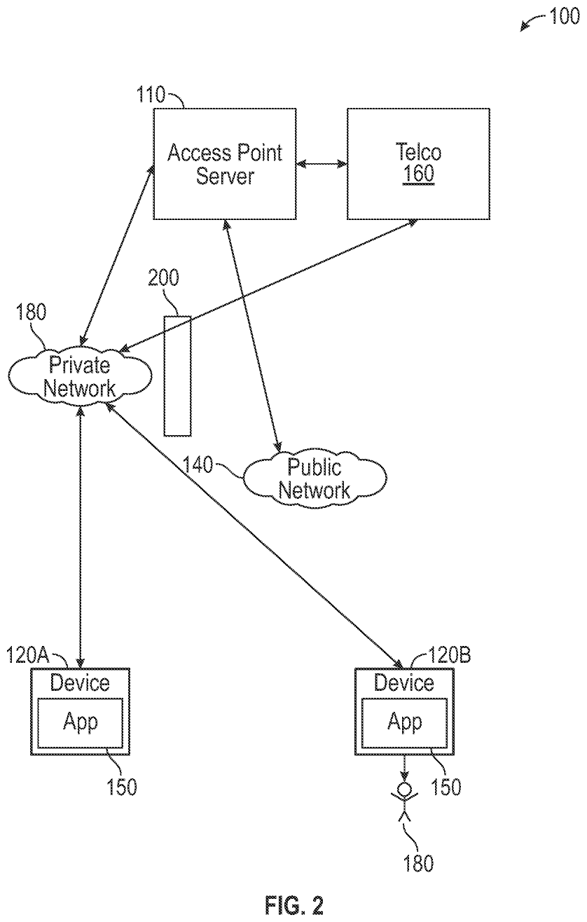

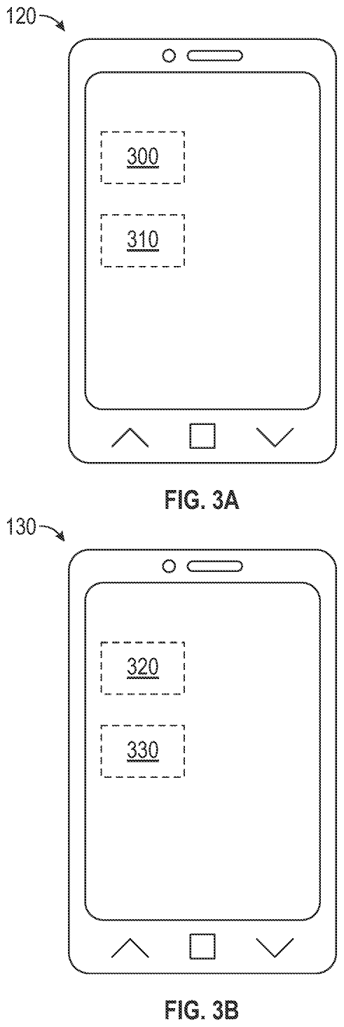

Once the first device 120A receives an indication that the second device has a closed communication SIM, the method performs an operation 406, where a secure communication session is established between the first device and the second device. In particular, the secure communication session can be established using the closed communication SIM of the first device and the closed communication SIM of the second device through the private network 180 where the access point server can facilitate establishing the secure communication session between the first device and the second device, as shown at 620 and 622 and in FIG. 2. Moreover, the secure communication session can be established over a private network that is separate from a public network, such as the private network 180, using the methodology discussed above.

Either before or after establishment of the secure communication session, the secure communication application selected by the requesting user can function to disable all non-secure communication session applications on the first device and turn off the open SIM of the first device during an operation 408 and at 624. As such, the only type of communication the first device is able to engage in is via the closed SIM of the device and the secure communication session. Furthermore, during the operation 408 at 626, the secure application on the second device can function to disable all non-secure communication session applications on the second device and turn off the open SIM of the second device.

In the illustration, during the operation 408, the secure communication application 502 on the device 102A functions to disable all non-secure communication session applications on the device 120A and turn off the open SIM 300 of the device 120A during the operation 408. Similarly, the secure communication application 502 operating on the device 130 functions to disable all non-secure communication session applications on the device 130 and turn off the open SIM 320 of the device 130 during the operation 408. At this point, the devices 120A and 130 are only able communicate via the closed communication SIMs 310 and 330 and the secure communication application 502.

As noted above, a secure communication session can be implemented using the secure communication application 502. When a user associated with the device 120A engages the secure communication application 502 to place the device 120A in a secure communication session mode, such as by selecting the user interface element 500, a user interface 504 can be presented on the device 120A, as shown in FIG. 5. The user interface 504 can list various applications 506-512 that can be used when the device 120A enters the secure communication session mode. The applications 506-512 can be pre-approved for use when the device 120A is in the secure communication session mode and when the device 120A is engaged in a secure communication session with another device. The applications 506-512 can include toggles 514-520 that allow a user to activate or deactivate an associated application for use during a secure communication session. Thus, the toggle 514 can be used to activate the application 506, as shown. If an application, such as the application 510, is deactivated, the application is not available during the secure communication session. However, the application may still be activated and available for local use.

Files, such as files 1000-1004 (FIG. 10), can also be associated with the applications 506-512. The files 1000-1004 can be locally accessible outside of a secure communication session. To further illustrate, if the files 1000-1004 are locally stored on the device 120A, the files 1000-1004 can be accessible to a user at the device 120A when the device 120A is not engaged in a secure communication session. Thus, a user at the device 120A can drag and drop data into the files 1000-1004 and select and remove/drag data out of the files 1000-1004 when the device 120A is not engaged in a secure communication session.

Moreover, when the files 1000-1004 are locally stored on the device 120A while the device 120A is in a secure communication session with the device 130, a user at the device 130 can access the files 1000-1004 via the secure communication session even when the files are locally stored on the device 120A. In particular, a user at the device 130 can drag and drop data into the files 1000-1004 and select and remove/drag data out of the files 1000-1004 when the device 130 when the device 120A and the device 130 are engaged in a secure communication session.

The user interface 504 can also list various connections 522-528 that are currently being used by the device 120A when the device is in a secure communication mode. When the device 120A is in the secure communication mode, communications can be restricted to communications via a secure communication session over the private network 180. Thus, public connections, such as the cellular connection 522, the WiFi™ connection 524, and the Bluetooth™ connection 526, can be deactivated, thereby minimizing security risk exposure which can lead to the problems discussed above relating to infiltration, appropriation of security and/or financial data, malware infiltration, and the like during a secure communication session. Moreover, the device 120A can be restricted from communication via the cellular connection 522, the WiFi™ connection 524, and the Bluetooth™ connection 526 while in the secure communication mode. In addition, a user associated with the device 120A can elect to have certain communication mediums usable during a secure communication session. In particular, the user can indicate that certain users can contact the user at the device 120A during a secure communication session, such as a family member of the user at the device 120A, via the cellular connection 522.

The user interface 504 can also include a card 530 having fields 532 and 534. The field 532 can relate to a security level of a remote connection while the field 534 can relate a security level of a local connection. The remote connection can relate to a connection that utilizes a connection mechanism that is not local to the user deice 120A, such a cellular connection. The local connection can relate to connection that utilizes a connection mechanism to the device 120A, such as Bluetooth, WiFi™, or IoT.

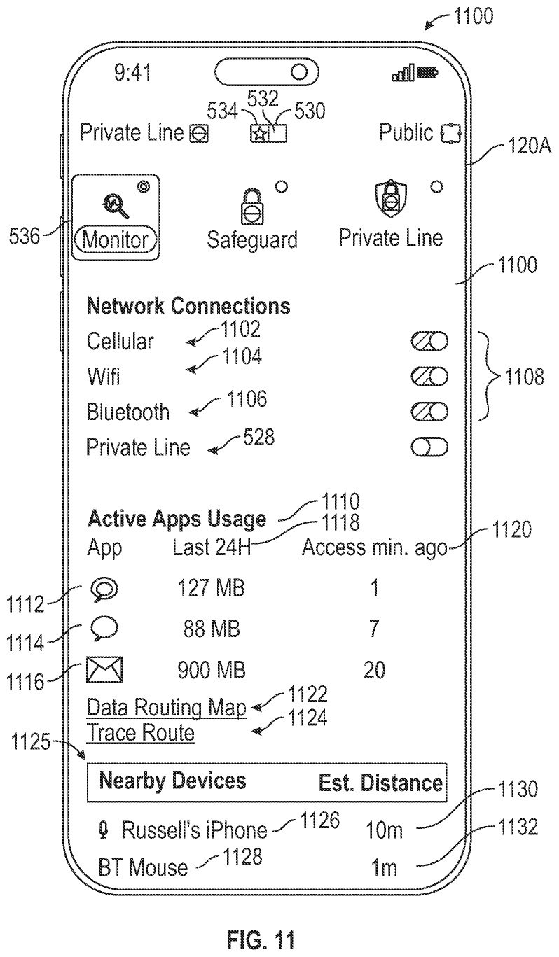

In addition to the secure communication mode, the device 120A can also have a monitor mode depicted by a user interface 536 and a safeguard mode depicted by a user interface element 538. Making reference to FIG. 11, when the monitor mode is selected via the user interface 536, a user interface 1100 can be provided on the device 120A. In the monitor mode, the device 120A can display what communication connections are available for use by the device 120A, a routing map that illustrates a path of data to and from the device 120A along with where blockages can occur, and other devices are in close proximity to the device 120A.

The user interface 1100 can have a listing of connections 1102-1106 that can correspond to connections that are available to the device 120A when the device is in the monitor mode. For example, a cellular connection 1102, a WiFi™ connection 1104, and a Bluetooth™ connection 1106 are all available to the device 120A when the device 120A is in the monitor mode. Each of the connections 1102-1106 can be enabled and disabled via toggles 1108. However, when in the monitor mode, the connection 528 may not be available. The user interface 1100 can also include an active applications usage portion 1110 that lists various applications 1112-1116 along with a data usage 1118 associated with each of the applications 1112-1116 and when each of the applications 1112-1116 were most recently accessed at 1120.

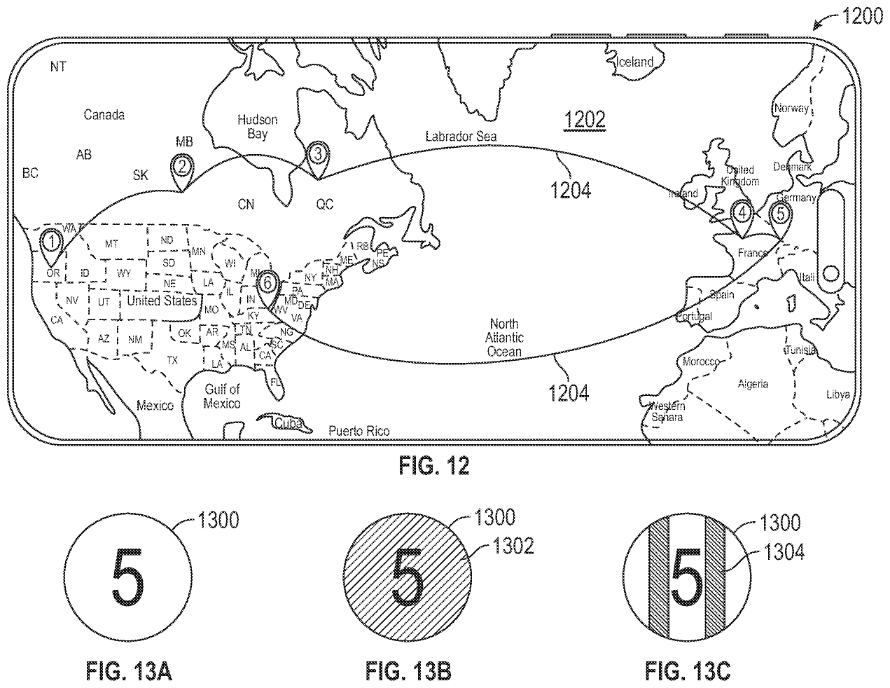

The user interface 1100 can also have a data routing map link 1122 that can be selectable to illustrate a route that data sent to and from the device 120A takes. When the data routing map link 1122 is selected, a user interface 1200 can be displayed on the device 120A, as shown with reference to FIG. 12. The user interface 1200 can include a map 1202 on which a path 1204 can be displayed. The path 1204 can illustrate where, geographically, data that is sent from the device 120A is being routed before arriving at an intended destination. Thus, if the device 120A is at a geographical location associated with the numeral “1” and is communicating with the device 130 in a monitor mode that is at a geographical location associated with the numeral “6,” as can be seen at the user interface 1200 and the path 1204, data sent from the device 120A goes through locations designated by the reference numerals “2,” “3,” “4,” and “5.”

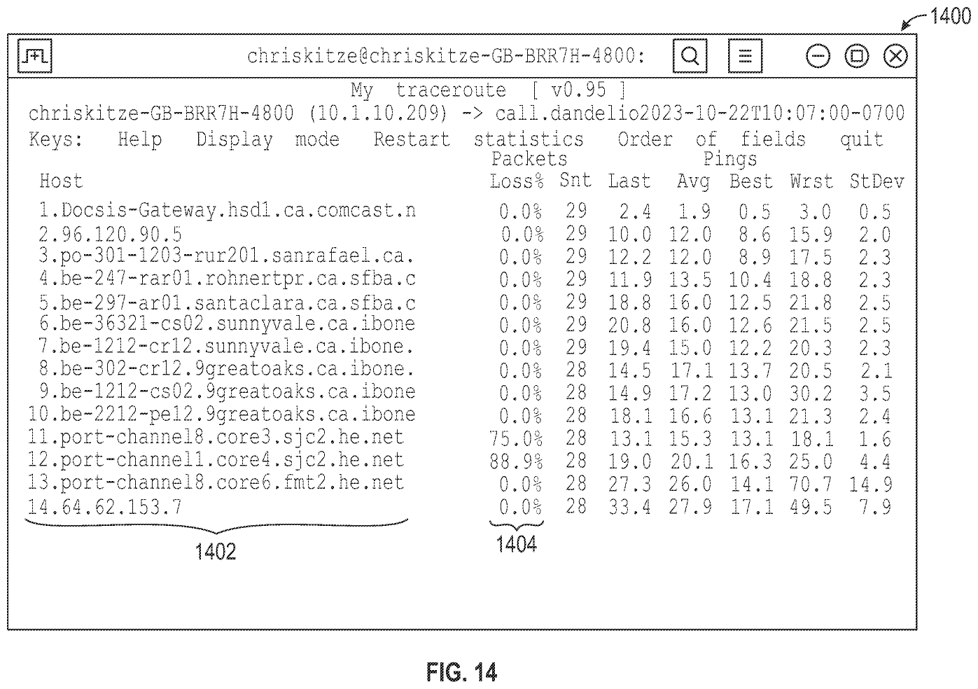

Moreover, the reference numerals can be highlighted to indicate a dropped packet performance as shown with reference to FIGS. 13A-13C. To further illustrate, if a dropped packet performance is less than twenty percent, a background 1300 can be clear, as shown with reference to FIG. 13A. If a dropped packet performance is between twenty percent and forty percent, the background 1300 can have indicators 1302, as shown with reference to FIG. 13B. If a dropped packet performance is greater than forty percent, the background 1300 can include indicators 1304, as shown with reference to FIG. 13C. While the background 1300 is described as being clear or having the indicators 1302 and 1304, the background 1300 can also include different colors, i.e., green can be associated with a dropped packet performance that is less than twenty percent, yellow can be associated with a dropped packet performance that is between twenty percent and forty percent, and red can be associated with a dropped packet performance that is greater than forty percent. In examples, the dropped packet percentage can relate to data sent being intercepted. Thus, if at the location having the reference numeral “5,” the dropped packet percentage is greater than forty percentage, this can correlate to an entity engaging in nefarious activities at the location having the reference numeral five.

Returning attention to FIG. 11, the user interface 1100 can also have a trace route link 1124 that is selectable to track packets that are dropped based on connection speed and IP address. In particular, when a user selects the trace route link 1124, a user interface 1400 (FIG. 14) can be provided that lists various hosts 1402 along with a packet loss percentage 1404. The user interface 1400 can be used to track data usage and show which IP addresses have connection problems, which can be reflected by the packet loss percentage 1404. Furthermore, the user interface 1400 can be configured to show a full connection path for data between a sender and a recipient, such as the path 1204.

In addition to the trace link 1124, the user interface 1100 can also have a list 1125 that shows what devices are within a communication range of the device 120A. The device 120A can include a scanning tool that can scan for devices that are within the communication range of the device 120A. Here, nearby devices list 1125 can include devices 1126 and 1128 that are capable of direct communication with the device 120A via a short-range communication medium, such as Bluetooth™, Zigbee™, or the like. In addition to listing the devices 1126 and 1128, the nearby devices list 1125 can also list distances 1130 and 1132 of each of the devices 1126 and 1128 relative to the device 120A. For example, the device 1126 may be a physical distance 1130 of 10 meters away from the device 120A. Furthermore, the device 1128 may be a physical distance 1132 of 1 meter away from the device 120A.

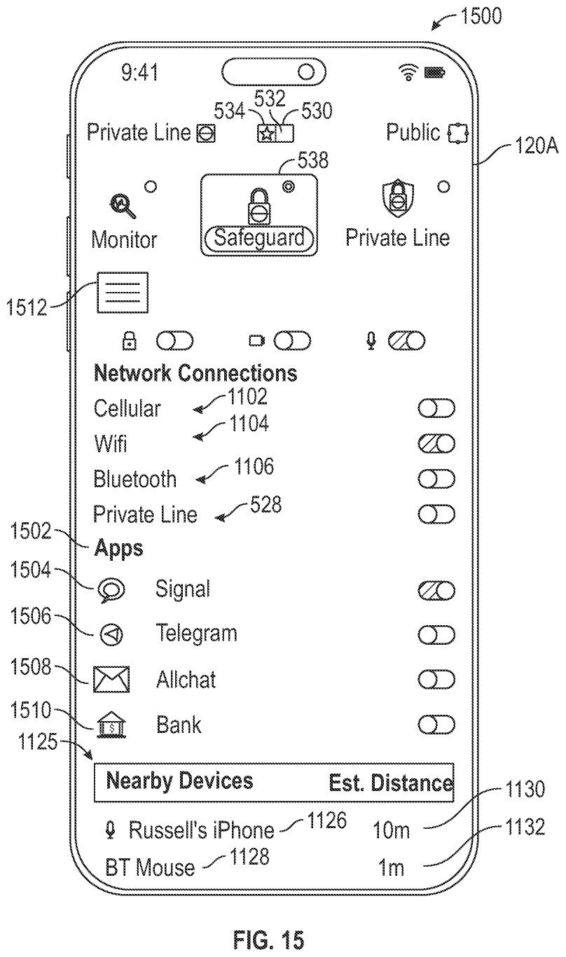

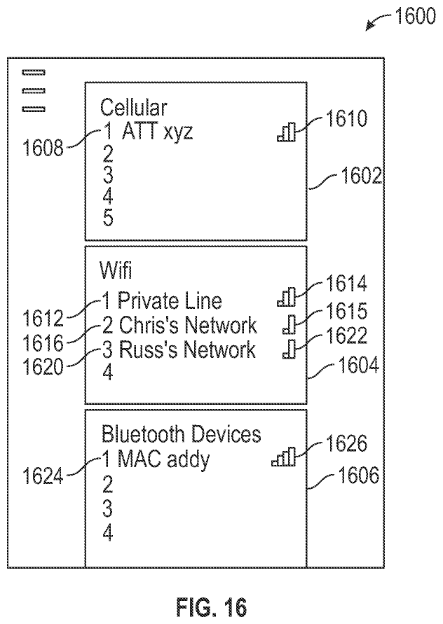

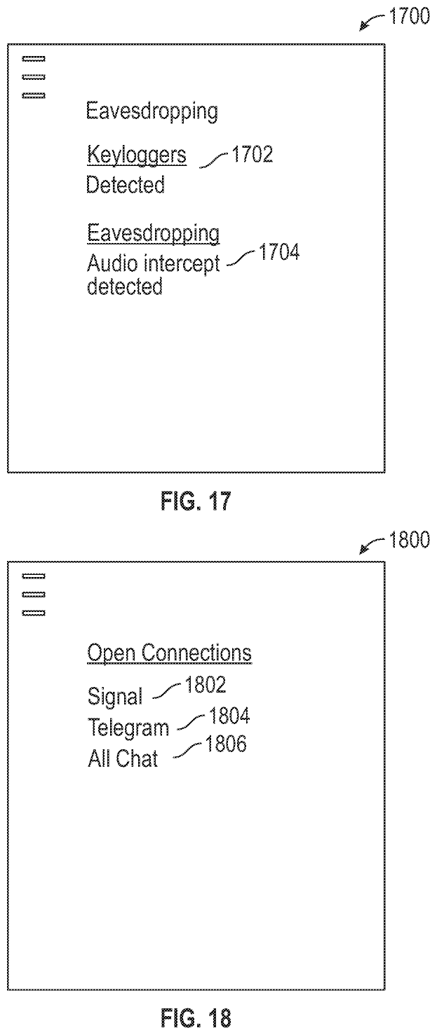

As noted above, in addition to the secure communication mode and the monitor mode, a safeguard mode can also be depicted by a user interface element 538. Now making reference to FIG. 15, when the user interface element 538 is selected by a user, a user interface 1500 can be presented on the device 120A, as shown with reference to FIG. 15. In the safeguard mode, the device 120A can be controlled to determine which of the connections 1102-1106 can be used during a communication session. However, the communication sessions implemented by one of the connections 1102-1106 can be different than the connection 528 that can be used during a secure communication session and implemented while in the secure communication mode. Thus, the device 120A can be controlled to communicate using the WiFi connection 1104 but not the cellular connection 1102 or the Bluetooth™ connection 1106. Similarly, the device 120A can be controlled to communicate using the cellular connection 1102 but not the WiFi connection 1104 or the Bluetooth™ connection 1106. Furthermore, the device 120A can be controlled to communicate using any combination of the connections 1102-1106. Moreover, the device 120A can be precluded from communicating via the connection 528 when the device is in the safeguard mode.

The user interface 1500 can also list which applications 1502 the device 120A still has access to in the safeguard mode. In examples, the number of type of applications available to the device 120A can be limited in comparison to the number of type of applications available to the device 120A in the monitor mode. Thus, an application 1504 may be available to the device 120A in the safeguard mode while applications 1506 and 1508 are only available when the device 120A is in the monitor mode. In addition, an application 1510 may only be available to the device 120A when the device 120A is in the secure communication mode.

The user interface 1500 can also have a hamburger menu 1512 that, when selected, can provide information, such as what communication networks are available to the device 120A, potential sources of eavesdroppers, and what connections are open on the device 120A. For example, upon selection, a list 1600 of communication networks that are available to the device 120A can be displayed. The available communication network list 1600 can be generated by the device 120A using the aforementioned scanning tool. The available communication network list 1600 can provide a list of potential threats to the device 120A.

The available communication network list 1600 can include listings according to type, such as a list of available cellular networks 1602, a list of available WiFi networks 1604, and a list of available Bluetooth™ connections 1606. The available cellular networks list 1602 can list cellular networks, such as ATT xyz 1608 having a signal strength 1610 as being available. The available WiFi network list 1604 can list WiFi networks that are available to the device 120A. Here, the available WiFi networks can include a private line network 1612 having a signal strength 1614, Chris's Network 1616 having a signal strength 1615, and Russ's Network 1620 having a signal strength 1622. The available Bluetooth™ connections list 1606 can list Bluetooth™ connections that are available to the device 120A, such as a MAC addy connection 1624 having a signal strength 1626. It should be pointed that while cellular, WiFi, and Bluetooth™ connections are listed as being available to the device 120A, any type of communication medium that is detected by the scanning tool of the device 120A can be listed in the available communication network list 1600.

In addition to the available communication network list 1600, when the hamburger menu 1512 is selected, a list of eavesdroppers 1700 can be displayed on the device 120A. The eavesdroppers list 1700 can list what types of entities have been detected as listening in on the device 120A. The types of eavesdroppers can include keyloggers 1702 and audio intercepts 1704. However, any type of entity engaged in eavesdropping can be listed in the cavesdroppers list 1700 upon detection, such as wiretapping into a microphone of the device 120A and/or the like.

Selection of the hamburger menu 1512 can also cause the device 120A to display an open connections list 1800. The open connections list 1800 can list various connections, such as connections operating as software applications, on the device 120A. The connections list 1800 can list applications 1802-1806 that are available for the device 120A. While the user interface 1500 lists the applications 1502 that can facilitate communications, the applications list 1800 can list additional applications that provide communication functionality to outside entities that a user of the device 120A may not be aware are active.

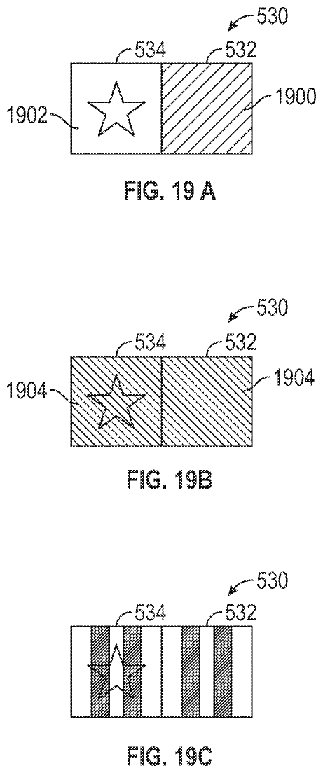

The user interface 504 can also include a card 530 having fields 532 and 534. The field 532 can relate to a security level of a remote connection while the field 534 can relate a security level of a local connection. Each of the user interfaces 1100 and 1500 can also include the card 530. The card 530 can be used to designate a security level associated with the fields 532 and 534. The field 534 can represent a status of a local connection, such as the applications 506-512, 1112-1116, and 1502-1510. The field 532 can represent a status of a remote connection, such as the connections 502 and 1102. As shown with reference to FIGS. 19A-19C, the fields can include different patterns that can correlate to different security levels. For example, the field 532 can have a pattern 1900 that can correlate to a secure remote connection, such as if the device 120A is in the secure communication mode and is engaged in a secure communication session. The field 534 can have a pattern 1902 that can correspond to a secure local connection, such as if the device 120A is in the secure communication mode and is engaged in a secure communication session.

In FIG. 19B, the fields 532 and 534 can have a pattern 1904, which can correspond to normal connections, such as if the device 120A is at a location where there are no security threats, such as basing the security threats on the location as shown with reference to FIGS. 12 and 13A-13B. A normal connection could correspond to an area where a dropped packet performance is less than twenty percent as discussed with reference to FIGS. 12 and 13A-13B. In FIG. 19C, the fields 532 and 534 can have a pattern 1904, which can correspond to a location that can pose a security threat. A location that can pose a security threat can correspond to an area where a dropped packet performance is greater than twenty percent as discussed with reference to FIGS. 12 and 13A-13B.

In examples, when the second device is contacted to establish a secure communication session, the second device may not include the application client 150, which, as noted above, provides the secure communication session functionality described herein. In these situations, is response to being contacted to establish a secure communication session, the second device can download the application client 150, which can then be used to provide the functionality described herein. In further examples, when the second device does not include the application client, the message requesting to establish the communication session can include a dropdown area having a selectable element that allows the user to download the application client 150.

In the discussion above, an eSIM was provisioned to the second device when the first device desired to initiate the establishment of a secure communication session with the second device. In examples, if the second device wishes to establish a secure communication session with the first device but the second device lacks an eSIM, the second device can determine if the first device has the pool of provisioned eSIMs. Upon determining that the first device has the pool of provisioned eSIMs, the second device can request that an eSIM from the pool of eSIMs be provisioned to the second device prior to attempting to establishing a secure communication session using the techniques described above. Here, the first device can get a notification indicating that the second device is attempting to provision an eSIM from the pool of the eSIMs.

While first and second devices have been described as establishing a connection with the private network 180, entities other than the first and second devices can establish direct connections with the private network in order to engage in a secure communication session. To further illustrate, proprietors of secure data, such as financial institutions, health care institutions, blockchain driven institutions, or the like, can establish a direct VPN connection with the private network 180 and can engage in secure communication sessions with the first device or the second device.

In the examples above, separate open and closed communication SIMs are being used to instantiate the secure communication session. The open communication SIM provides communication session via an open communication network, such as the public network 140. Moreover, the secure communication session is provided over the private network 180. In further examples, a secure communication session can be provided entirely over the public network 140 that has the same advantages and functionality as described herein.

In this example, a split tunnel virtual private network (VPN) can be established. The split tunnel VPN can be split into a public facing VPN tunnel and a private facing VPN tunnel. Each of the public facing VPN tunnel and the private facing VPN tunnel can include all of the features disclosed herein. Thus, a closed SIM does not need to be provisioned and the open SIM can be used to establish and conduct a secure communication session. The public facing VPN can allow for open communications and the private facing VPN only allows for the secure communication session.

The split tunnel VPN can take the internet, i.e., the internet pipe, and dedicate a portion of the pipe for the private side and firewalls out any non-approved applications from communicating with the ether of the devices associated with the secure communication session. The public side can fill the rest of the “pipe” so the device can receive regular internet data and run other apps at the same time. Since the public facing VPN implements an internet pipe, the operation of all applications resident on each of the first device and the second device as described above can be facilitated through the pubic facing VPN.

Here, each of the devices involved in the secure communication session can have a public facing side and a private connection side. An access point, such as the access point server 110 can facilitate communication with each of the devices involved in the secure communication session. the access point server 110 can authenticate and mediate communication through peer-to-peer communication without a central server.

Furthermore, only those applications that are for use during the secure communication session as described above can be implemented via the private-facing VPN while the application for use during non-secure communications as described can be used via the public facing VPN. This can be simultaneously done such that all applications described above can be running at the same time, i.e., some or all applications are not disabled as described above.

### Modules, Components, and Logic

Certain embodiments are described herein as including logic or a number of components, modules, or mechanisms. Modules may constitute either software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application programming interfaces (APIs)).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special-purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Software Architecture

FIG. 20 is a block diagram 2000 illustrating a software architecture 2002, which may be installed on any one or more of the devices described above. FIG. 20 is merely a non-limiting example of a software architecture, and it will be appreciated that many other architectures may be implemented to facilitate the functionality described herein. The software architecture 2002 may be implemented by hardware such as a machine 2100 of FIG. 21 that includes processors 2110, memory 2130, and I/O components 2150. In this example, the software architecture 2002 may be conceptualized as a stack of layers where each layer may provide a particular functionality. For example, the software architecture 2002 includes layers such as an operating system 804, libraries 2006, frameworks 2008, and applications 2010. Operationally, the applications 2010 invoke application programming interface (API) calls 2012 through the software stack and receive messages 2014 in response to the API calls 2012, according to some implementations.

In various implementations, the operating system 804 manages hardware resources and provides common services. The operating system 804 includes, for example, a kernel 2020, services 2022, and drivers 2024. The kernel 2020 acts as an abstraction layer between the hardware and the other software layers in some implementations. For example, the kernel 2020 provides memory management, processor management (e.g., scheduling), component management, networking, and security settings, among other functionality. The services 2022 may provide other common services for the other software layers. The drivers 2024 may be responsible for controlling or interfacing with the underlying hardware. For instance, the drivers 2024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 2006 provide a low-level common infrastructure that may be utilized by the applications 2010. The libraries 2006 may include system libraries 2030 (e.g., C standard library) that may provide functions such as memory allocation functions, string manipulation functions, mathematic functions, and the like. In addition, the libraries 2006 may include API libraries 2032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 2006 may also include a wide variety of other libraries 2034 to provide many other APIs to the applications 2010.

The frameworks 2008 provide a high-level common infrastructure that may be utilized by the applications 2010, according to some implementations. For example, the frameworks 2008 provide various graphic user interface (GUI) functions, high-level resource management, high-level location services, and so forth. The frameworks 2008 may provide a broad spectrum of other APIs that may be utilized by the applications 2010, some of which may be specific to a particular operating system or platform.

In an example embodiment, the applications 2010 include a home application 2050, a contacts application 2052, a browser application 2054, a book reader application 2056, a location application 2058, a media application 2060, a messaging application 2062, a game application 2064, and a broad assortment of other applications such as a third-party application 2066. According to some embodiments, the applications 2010 are programs that execute functions defined in the programs. Various programming languages may be employed to create one or more of the applications 2010, structured in a variety of manners, such as object-orientated programming languages (e.g., Objective-C, Java, or C++) or procedural programming languages (e.g., C or assembly language). In a specific example, the third-party application 2066 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 2066 may invoke the API calls 2012 provided by the mobile operating system (e.g., the operating system 804) to facilitate functionality described herein.

### Example Machine Architecture and Machine-Readable Medium

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2116, sequentially or otherwise, that specify actions to be taken by the machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory 2130, and I/O components 2150, which may be configured to communicate with each other via a bus 2102. In an example embodiment, the processors 2110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2112 and a processor 2114 that may execute the instructions 2116. The term “processor” is intended to include multi-core processors that may comprise two or more independent processors (also referred to as “cores”) that may execute instructions contemporaneously. Although FIG. 21 shows multiple processors, the machine 2100 may include a single processor with a single core, a single processor with multiple cores (e.g., a multi-core processor), multiple processors with a single core, multiple processors with multiple cores, or any combination thereof.

The memory 2130 may include a main memory 2132, a static memory 2134, and a storage unit 2136 accessible to the processors 2110 via the bus 2102. The storage unit 2136 may include a machine-readable medium 2138 on which are stored the instructions 2116 embodying any one or more of the methodologies or functions described herein. The instructions 2116 may also reside, completely or at least partially, within the main memory 2132, within the static memory 2134, within at least one of the processors 2110 (e.g., within the processor's cache memory), or any suitable combination thereof, during execution thereof by the machine 2100. Accordingly, in various implementations, the main memory 2132, the static memory 2134, and the processors 2110 are considered machine-readable media 2138.

As used herein, the term “memory” refers to a machine-readable medium 2138 able to store data temporarily or permanently and may be taken to include, but not be limited to, random-access memory (RAM), read-only memory (ROM), buffer memory, flash memory, and cache memory. While the machine-readable medium 2138 is shown in an example embodiment to be a single medium, the term “machine-readable medium” should be taken to include a single medium or multiple media (e.g., a centralized or distributed database, or associated caches and servers) able to store the instructions 2116. The term “machine-readable medium” shall also be taken to include any medium, or combination of multiple media, that is capable of storing instructions (e.g., instructions 2116) for execution by a machine (e.g., machine 2100), such that the instructions, when executed by one or more processors of the machine (e.g., processors 2110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 2150 include a wide variety of components to receive input, provide output, produce output, transmit information, exchange information, capture measurements, and so on. In general, it will be appreciated that the I/O components 2150 may include many other components that are not shown in FIG. 21. The I/O components 2150 are grouped according to functionality merely for simplifying the following discussion and the grouping is in no way limiting. In various example embodiments, the I/O components 2150 include output components 2152 and input components 2154. The output components 2152 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 2154 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 2150 include biometric components 2156, motion components 2158, environmental components 2160, or position components 2162, among a wide array of other components. For example, the biometric components 2156 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2158 include acceleration sensor components (e.g., accelerometer), gravitation sensor components, rotation sensor components (e.g., gyroscope), and so forth. The environmental components 2160 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 2162 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 180 or devices 2170 via a coupling 2182 and a coupling 2172, respectively. For example, the communication components 2164 include a network interface component or another suitable device to interface with the networks 140/180. In further examples, the communication components 2164 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2170 may be another machine or any of a wide variety of peripheral devices (e.g., a peripheral device coupled via a USB).

Moreover, in some implementations, the communication components 2164 detect identifiers or include components operable to detect identifiers. For example, the communication components 2164 include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 2164, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the networks 140/180 may be an ad hoc network, an intranet, an extranet, a VPN, a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 180 or a portion of the network 180 may include a wireless or cellular network and the coupling 2182 may be a Code Division Multiple Access (CDMA) connection, a Global System for Mobile communications (GSM) connection, or another type of cellular or wireless coupling. In this example, the coupling 2182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 2116 are transmitted or received over the networks 140/180 using a transmission medium via a network interface device (e.g., a network interface component included in the communication components 2164) and utilizing any one of a number of well-known transfer protocols (e.g., Hypertext Transfer Protocol (HTTP)). Similarly, in other example embodiments, the instructions 2116 are transmitted or received using a transmission medium via the coupling 2172 (e.g., a peer-to-peer coupling) to the devices 2170. The term “transmission medium” shall be taken to include any intangible medium that is capable of storing, encoding, or carrying the instructions 2116 for execution by the machine 2100, and includes digital or analog communications signals or other intangible media to facilitate communication of such software.

Furthermore, the machine-readable medium 2138 is non-transitory (in other words, not having any transitory signals) in that it does not embody a propagating signal. However, labeling the machine-readable medium 2138 as “non-transitory” should not be construed to mean that the medium is incapable of movement; the medium should be considered as being transportable from one physical location to another. Additionally, since the machine-readable medium 2138 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method for enabling a secure communication session, the method comprising:
sending a request from a first device to a second device, the request relating to establishing a communication session between the first device and the second device, the first device having an open communication subscriber identity module (SIM) and a closed communication SIM, the first device open communication SIM being logically separate and distinct from the first device closed communication SIM, the second device having an open communication SIM;
receiving an indication of a determination that the second device has a closed communication SIM, the second device open communication SIM being logically separate and distinct from the second device closed communication SIM;
establishing a communication session when the determination is received that the second device has the second device closed communication SIM, wherein the communication session is established between the first device closed communication SIM and the second device closed communication SIM; and
disabling the first device open communication SIM such that communications with the first device are only possible via the first device closed communication SIM during the established communication session.

2. The method of claim 1, wherein the second device open communication SIM is disabled such that communications with the second device are only possible via the second device closed communication SIM during the established communication session.

3. The method of claim 1, wherein the first device has a pool of closed communication SIMs and the method further comprises temporarily provisioning the second device closed communication SIM from the pool of closed communication SIMs.

4. The method of claim 3, wherein each of the open communication SIMs of the first and second devices and each of the closed communication SIMs of the first and second devices are embedded SIMs.

5. The method of claim 1, further comprising presenting a user interface at the first device, the user interface comprising:
a user interface element switchable between a plurality of positions including:
a first position that is selectable to place the first device in a monitor mode that monitors an environment around the first device and tracks data transfer between the first device and intended recipients of the data transfer;
a second position that is selectable to place the first device in a privacy mode that disables location services associated with the first device; and
a third position that is selectable to place the first device in a secure communication session mode that disables the first device open communication SIM and a software instance unassociated with the communication session.

6. The method of claim 5, wherein when the second position is selected, the user interface further comprises a listing that includes:
a listing of networks each having a selectable element configured to engage or disengage a communication medium associated with the first device open communication SIM; and
a listing of software instances each having a selectable element configured to engage or disengage each software instance of the listing of software instances.

7. The method of claim 5, wherein the communication session has a software instance associated therewith and when the third position is selected, only the software instance associated with the communication session is enabled.

8. The method of claim 1, wherein the communication session has a software instance associated therewith and the method further comprises:
enabling only the software instance associated with the communication session; and
disabling software instances unassociated with the communication session.

9. The method of claim 8, wherein the software instance associated with communication session includes a file sharing application that allows for a file to be only shared via the communication session.

10. The method of claim 1, wherein the indication of the determination that the second device has the closed communication SIM is received from an access point selected by a user associated with the first device.

11. The method of claim 10, wherein the second device has an identifier and the indication of the determination that the second device has the closed communication SIM is determined based on comparing the second device identifier with a list of device identifiers.

12. A system comprising:
a memory that stores instructions; and
one or more processors configured by the instructions to perform operations comprising:
sending a request from a first device to a second device, the request relating to establishing a communication session between the first device and the second device, the first device having an open communication subscriber identity module (SIM) and a closed communication SIM, the first device open communication SIM being logically separate and distinct from the first device closed communication SIM, the second device having an open communication SIM;
receiving an indication of a determination that the second device has a closed communication SIM, the second device open communication SIM being logically separate and distinct from the second device closed communication SIM;
establishing a communication session when the determination is received that the second device has the second device closed communication SIM, wherein the communication session is established between the first device closed communication SIM and the second device closed communication SIM; and
disabling the first device open communication SIM such that communications with the first device are only possible via the first device closed communication SIM during the established communication session.

13. The system of claim 12, wherein the second device open communication SIM is disabled such that communications with the second device are only possible via the second device closed communication SIM during the established communication session.

14. The system of claim 12, wherein the first device has a pool of closed communication SIMs and the method further comprises temporarily provisioning the second device closed communication SIM from the pool of closed communication SIMs and each of the open communication SIMs of the first and second devices and each of the closed communication SIMs of the first and second devices are embedded SIMs.

15. The system of claim 12, the operations further comprising presenting a user interface at the first device, the user interface comprising:
a user interface element switchable between a plurality of positions including:
a first position that is selectable to place the first device in a monitor mode that monitors an environment around the first device and tracks data transfer between the first device and intended recipients of the data transfer;
a second position that is selectable to place the first device in a privacy mode that disables location services associated with the first device;
a third position that is selectable to place the first device in a secure communication session mode that disables the first device open communication SIM and a software instance unassociated with the communication session, wherein the communication session has a software instance associated therewith and when the third position is selected, only the software instance associated with the communication session is enabled, wherein when the second position is selected, the user interface further comprises a listing that includes:
a listing of networks each having a selectable element configured to engage or disengage a communication medium associated with the first device open communication SIM; and
a listing of software instances each having a selectable element configured to engage or disengage each software instance of the listing of software instances.

16. The system of claim 12, wherein the communication session has a software instance associated therewith that includes a file sharing application that allows for a file to be only shared via the communication session and the operations further comprise:
enabling only the software instance associated with the communication session; and
disabling software instances unassociated with the communication session.

17. A method for enabling a secure communication session, the method comprising:
sending a request from a first device to a second device, the request relating to establishing a communication session between the first device and the second device, the first device having an open communication subscriber identity module (SIM), the second device having an open communication SIM; and
establishing a split virtual private network (VPN) between the first device and the second device via the open communication SIM of the first device and the open communication SIM of the second device, the split VPN having a public facing VPN and a private facing VPN, wherein the public facing VPN allows for open communications and the private facing VPN only allows for the secure communication session.

18. The method of claim 17, wherein the public facing VPN implements an internet pipe to facilitate the operation of all applications resident on each of the first device and the second device while at the same time allowing applications only for use during the secure communication session to be run simultaneously with the applications being implemented via the public facing VPN.

19. The method of claim 17, the method further comprising presenting a user interface at the first device using the public facing VPN, the user interface comprising:
a user interface element switchable between a plurality of positions including:
a first position that is selectable to place the first device in a monitor mode that monitors an environment around the first device and tracks data transfer between the first device and intended recipients of the data transfer;
a second position that is selectable to place the first device in a privacy mode that disables location services associated with the first device;
a third position that is selectable to place the first device in a secure communication session mode that disables the first device open communication SIM and a software instance unassociated with the communication session, wherein the communication session has a software instance associated therewith and when the third position is selected, only the software instance associated with the communication session is enabled, wherein when the second position is selected, the user interface further comprises a listing that includes:
a listing of networks each having a selectable element configured to engage or disengage a communication medium associated with the first device open communication SIM; and
a listing of software instances each having a selectable element configured to engage or disengage each software instance of the listing of software instances.

20. The method of claim 17, wherein the communication session has a software instance associated therewith that includes a file sharing application that allows for a file to be only shared via the private facing VPN.
